(19) United States
(12) Patent Application Publication
(10) Pub. No.: US 2002/0189290 A1
(43) Pub. Date: Dec. 19, 2002

(54) System and method for forming and quenching glass sheets

(75) Inventor: Terry A. Bennett, Northwood, OH (US)

Correspondence Address: James A. Kushman, Brooks & Kushman P.C., 22nd Floor, 1000 Town Center, Southfield, MI, 48075-1351, US

(73) Assignee: Glasstech, Inc., Perrysburg, OH (US)

(21) Appl. No.: 09/884,848

(22) Filed: Jun. 19, 2001

(51) Int. Cl. C03B 23/03

(52) U.S. Cl. 65/104; 65/273; 65/114; 65/268

(57) ABSTRACT

A system (10) and method for forming and quenching glass sheets with curvatures both along and transverse to a direction of conveyance includes a furnace (12) having an exit end (22) with a roll bending station (14), a press bending station located downstream from the exit end of the furnace and having a lower ring mold (46) and an upper press mold (48) operated by an actuator (50), and a quench station (18) that provides toughening of the formed glass sheet. The location of the roll bending station (14) with sets (30) of inclined bending rolls (32) having increasing inclinations along the direction of conveyance together with the external press station (16) and the quench station (18) provides the glass sheet forming without the necessity for excessive heating so that the glass is sufficiently hot upon quenching to provide the toughening.

### BACKGROUND OF THE INVENTION

1. Field of the Invention

This invention relates to a system and to a method for forming and quenching glass sheets.

2. Background Art

Glass sheets have previously been formed by a conveyor roll station that is located downstream from a heating furnace and upstream from a press bending station. Such roll forming stations as disclosed by U.S. Pat. No. 5,368,625 Mizusugi and U.S. Pat. No. 5,545,245 Mizusugi have horizontal rolls and laterally spaced sets of inclined rolls located externally of the furnace with the rolls of each inclined set having progressively increasing inclination along the direction of conveyance to roll form each heated glass sheet prior to further conveyance thereof to the press station where the glass sheet is press bent.

As disclosed by French Patent 2221409 of inventor Maurice Nedelec, glass sheet bending has also previously been performed by conveyor rolls that are supported and rotatively driven from outside of a furnace heating chamber with the rolls projecting inwardly into the furnace to receive a heated glass sheet prior to simultaneously tilting of the rolls to form the heated glass sheet within the furnace.

### SUMMARY OF THE INVENTION

One object of the present invention is to provide an improved system for forming and quenching glass sheets.

In carrying out the above object, the system for forming and quenching glass sheets in accordance with the invention includes a furnace having entry and exit ends and including a heating chamber having a conveyor for conveying glass sheets along a direction of conveyance through the furnace from the entry end to the exit end. The exit end of the furnace includes a roll bending station within the heating chamber. This roll bending station includes a roll conveyor having horizontally extending conveyor rolls that are rotatively driven and spaced horizontally within the heating chamber along the direction of conveyance extending laterally with respect thereto to support and convey the heated glass sheets. The roll bending station also has a pair of sets of bending rolls that are spaced laterally with respect to each other within the heating chamber along the direction of conveyance. A drive mechanism supports the bending rolls of each set at progressively increasing inclinations along the direction of conveyance and provides rotational driving of the bending rolls to provide bending of the conveyed glass sheets along a direction transverse to the direction of conveyance. A press bending station of the system is located externally of the furnace downstream along the direction of conveyance from the exit end of the furnace to receive the bent glass sheets from the exit end of the furnace. The press bending station has a lower ring mold and an upper press mold that have curved shapes along and transverse to the direction of conveyance. An actuator of the press bending station provides relative vertical movement between the lower ring mold and the upper press mold to bend a glass sheet therebetween and cooperate with the roll bending station in forming the glass sheet with curvatures along and transverse to the direction of conveyance. A quench station of the system rapidly cools the formed glass sheet to provide toughening.

In the preferred construction of the system, the drive mechanism of the bending rolls is located externally of the furnace with the bending rolls projecting inwardly into the furnace.

In the preferred construction of the system, the press bending station actuator moves the lower ring mold vertically to provide the glass sheet forming. In addition, the press bending station actuator in the preferred construction moves the upper press mold vertically to provide the glass sheet forming. More specifically, the press bending station actuator preferably moves both the lower ring mold and the upper press mold vertically to provide the glass sheet forming.

Another object of the present invention is to provide an improved method for forming and quenching glass sheets.

In carrying out the immediately preceding object, the method for forming and quenching glass sheets in accordance with the invention is performed by conveying a glass sheet within a heating chamber of a furnace from an entry end thereof toward an exit end thereof to provide heating thereof for forming. The conveyance of the heated glass sheet is continued onto rotary horizontally extending rolls within the furnace heating chamber adjacent the exit end of the furnace to engage opposite lateral sides of the roll conveyed glass sheet with a pair of sets of rotatively driven bending rolls that are spaced from each other within the furnace heating chamber with each set having a plurality of bending rolls spaced along the direction of conveyance with progressively increasing inclinations to provide bending of the conveyed glass sheets along a direction transverse to the direction of conveyance. The bent glass sheet is conveyed out of the heating chamber of the furnace through the exit end thereof to between a lower ring mold and an upper press mold that have curved shapes along and transverse to the direction of conveyance. Relative vertical movement provided between the lower ring mold and the upper press mold bend a glass sheet therebetween and cooperate with the initial roll bending to form the glass sheet with curvatures along and transverse to the direction of conveyance. Thereafter, rapid cooling of the formed glass sheet provides toughness.

In the preferred practice of the glass sheet forming and quenching method, each set of bending rolls is rotatively supported and driven from externally of the furnace with the bending rolls thereof projecting inwardly into the heating chamber.

In the preferred practice of the glass sheet forming and quenching method, the lower ring mold is moved vertically to press bend the glass sheet. In this preferred method, the upper press mold is also moved vertically to press bend the glass sheet. More specifically, the preferred practice of the method has both the lower ring mold and the upper press mold moved vertically to press bend the glass sheet.

The objects, features and advantages of the present invention are readily apparent from the following detailed description of the preferred embodiment when taken in connection with the accompanying drawings.

### BRIEF DESCRIPTION OF THE DRAWINGS

FIG. 1 is a side elevational view of a system for forming and quenching glass sheets in accordance with the present invention to perform the method thereof that provides toughened formed glass sheets.

FIG. 2 is a cross sectional view taken through the system along the direction of line 2-2 in FIG. 1 at an exit end of the system furnace to illustrate a roll bending station having horizontal and inclined rolls on which each heated glass sheet is conveyed for roll forming prior to exiting the furnace in preparation for press bending.

FIG. 3 is a cross sectional view taken through the system along the direction of line 3-3 in FIG. 1 to illustrate the construction of a press bending station of the system as having a lower ring mold and an upper press mold that are movable between the solid and phantom line indicated positions to press bend the initially roll formed glass sheet and provide it with curvatures both along and transverse to the direction of conveyance through the system.

FIG. 4 is a side view of the press bending station taken along the direction of line 4-4 in FIG. 3 to further illustrate its construction.

FIG. 5 is a top plan view taken along the direction of line 5-5 in FIG. 4 to illustrate the manner in which the lower press mold is received by a conveyor wheel bed that receives the roll formed glass sheet from the roll bending station prior to the press bending.

### DETAILED DESCRIPTION OF THE PREFERRED EMBODIMENT

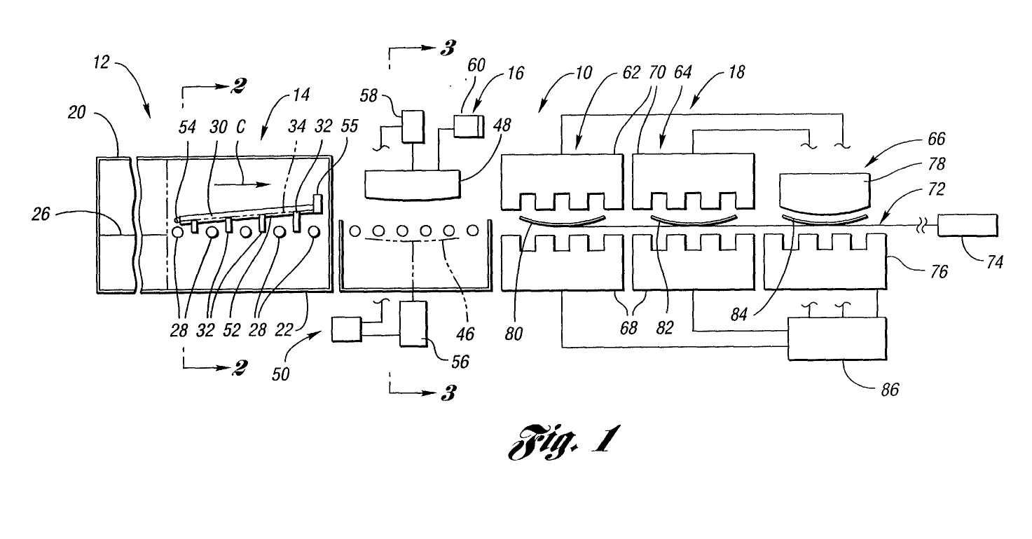

With reference to FIG. 1 of the drawings, a system for forming and quenching glass sheets is generally indicated by 10 and embodies the present invention as well as performing the method thereof as is hereinafter more fully described. Both the system and the method of the invention will be described in an integrated manner to facilitate an understanding of all aspects of the invention.

With continuing reference to FIG. 1, the system 10 includes a furnace 12 having a roll bending station 14 that is hereinafter more fully described. Downstream to the right of the furnace roll bending station 14 along a direction of conveyance C, the system 10 includes a press bending station 16 that provides press bending of glass sheets that have previously been roll bent. A quench station 18 of the system is located downstream to the right from the press bending station 16 and provides rapid cooling of a glass sheet that has cooperatively been formed by the roll bending station 14 and the press bending station 16.

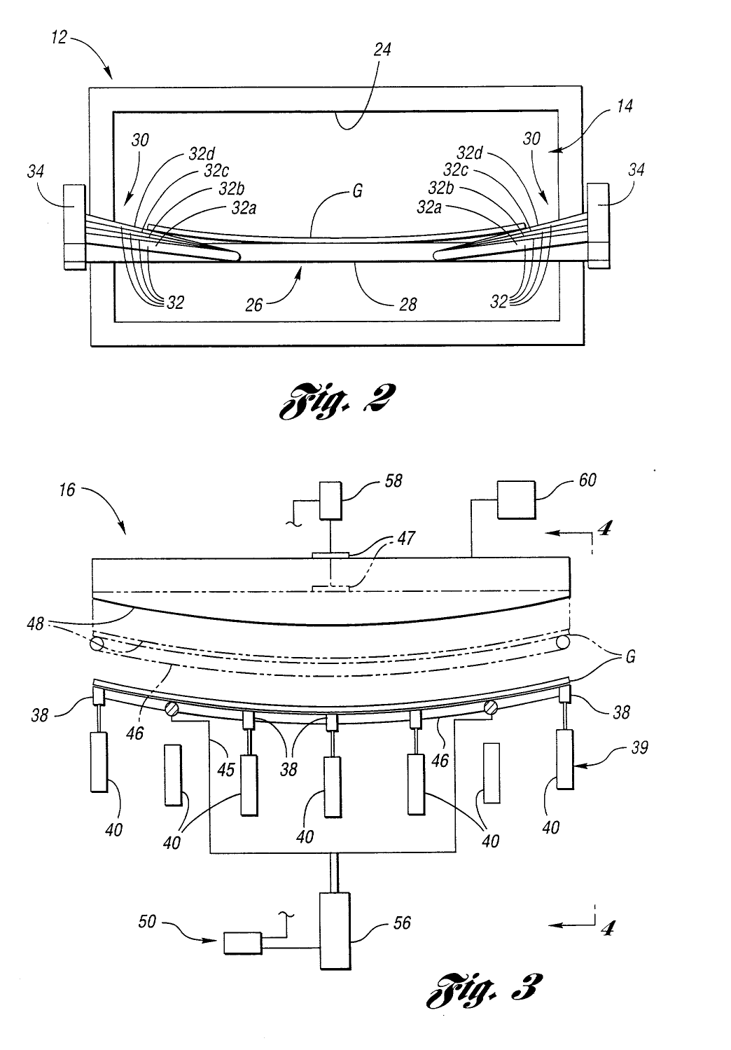

As illustrated by continuing reference to FIG. 1, the furnace 12 has entry and exit ends 20 and 22 and includes a heating chamber 24 (FIG. 2) having a conveyor 26 for conveying glass sheets along the direction of conveyance C through the furnace from the entry end to the exit end. The conveyor 26 can be either a conventional gas hearth or a roller conveyor that conveys glass sheets during heating from ambient temperature to a sufficiently high temperature to permit forming and quenching that toughens the glass sheet by either heat strengthening or more rapid cooling that provides tempering.

The furnace exit end 22 illustrated in FIG. 1 as previously stated includes a roll bending station 14. This roll bending station 14 as also illustrated in FIG. 2 includes horizontally extending conveyor rolls 28 that are rotatively driven and spaced horizontally within the heating chamber along the direction of conveyance C extending laterally with respect thereto to support and convey the heated glass sheets. The roll bending station 14 also includes a pair of sets 30 of bending rolls 32, with the bending roll sets 30 spaced laterally with respect to each other within the heating chamber 24 along the direction of conveyance. A drive mechanism collectively indicated by 34 supports the bending rolls 32 of each set at progressively increasing inclinations along the direction of conveyance as illustrated by reference numerals 32ₐ, 32_{b}, 32_{c}, and 32_{d} in FIG. 2. The conveyance of each heated glass sheet G along the direction of conveyance on the horizontal rolls 28 in cooperation with the bending rolls 32 provides bending of the glass sheet G along a direction transverse to the direction of conveyance as shown in FIG. 2. For example, in a five foot length of the roll bending station, 18 of the bending rolls 32 with a diameter of about 1 inch alternate with 18 of the horizontal conveyor rolls 28 with a diameter of about 2 inches, and there is only about 1/16 of an inch spacing between the rolls. While the lateral center of the conveyed glass sheet is supported by the center of the horizontal conveyor rolls 28, the increasing inclinations of the bending rolls 32 along the direction of conveyance provides engagement thereof with opposite lateral sides of the conveyed glass sheet within the heating chamber 32 to provide bending of the glass sheet along a direction transverse to the direction of conveyance as illustrated in FIG. 2. Greater inclination of the bending rolls 32 thus provides greater bending transverse to the direction of conveyance. Also, the smaller diameter bending rolls 32 are rotatively driven at a greater rate than the larger diameter horizontal conveyor rolls 28 so as to have the same roll surface speeds at the glass contact locations.

With combined reference to FIGS. 1 and 3-5, the press bending station 16 as previously mentioned is located externally of the furnace 12 downstream from its exit end 22 to receive the roll bent glass sheet from the roll bending station 14. More specifically, the press bending station includes a lower wheel bed 36 having rotatively driven conveyor wheels 38. More specifically, as illustrated in FIGS. 3-5, the lower wheel bed 36 includes a lower support 39 having a plurality of drive rails 40 that extend along the direction of conveyance in a laterally spaced relationship from each other. Each drive rail 40 supports a plurality of the conveyor wheels 38 and includes a continuous drive member 42 to which the associated conveyor wheels 38 have detachable connections 44 that permit selected conveyor wheels to be removed so that the conveyor wheel bed 36 can receive an associated lower ring mold as described below.

As illustrated in FIGS. 3-5, the press bending station 16 has a lower mount 45 that supports a lower ring mold 46 and also has an upper mount 47 that supports an upper press mold 48. Both the lower ring mold and the upper press mold have curved shapes both along and transverse to the direction of conveyance of the glass sheets through the system. An actuator of the press bending station 16 is collectively indicated by 50 and provides relative vertical movement between the lower mold ring 46 and the upper press mold 48 to bend the glass sheet therebetween and cooperate with the roll bending station 14 in forming the glass sheet with transverse curvatures. Thus, the glass sheet is formed with curvature along the direction of conveyance and transverse to the direction of conveyance by conforming to the shape between the lower ring mold 46 and the upper press mold 48.

With reference to FIG. 2, the bending roll drive mechanism 34 is located externally of the furnace 12 at each side thereof with the bending rolls 32 projecting inwardly into the furnace within its heating chamber 24. As shown in FIG. 1, the drive mechanism 34 has a support 52 that supports and rotatively drives the outboard ends of the bending rolls 32 of each set and has a pivotal connection 54 at its upstream end as well as an adjuster 55 at its downstream end for adjusting the inclination of the bending rolls 32 to provide the desired curvature transverse to the direction of conveyance, with greater inclination providing a greater amount of roll bending transverse to the direction of conveyance. The drive mechanism 34 is mounted on a suitable slideway to provide lateral adjustment that accommodates glass sheets of different lateral widths.

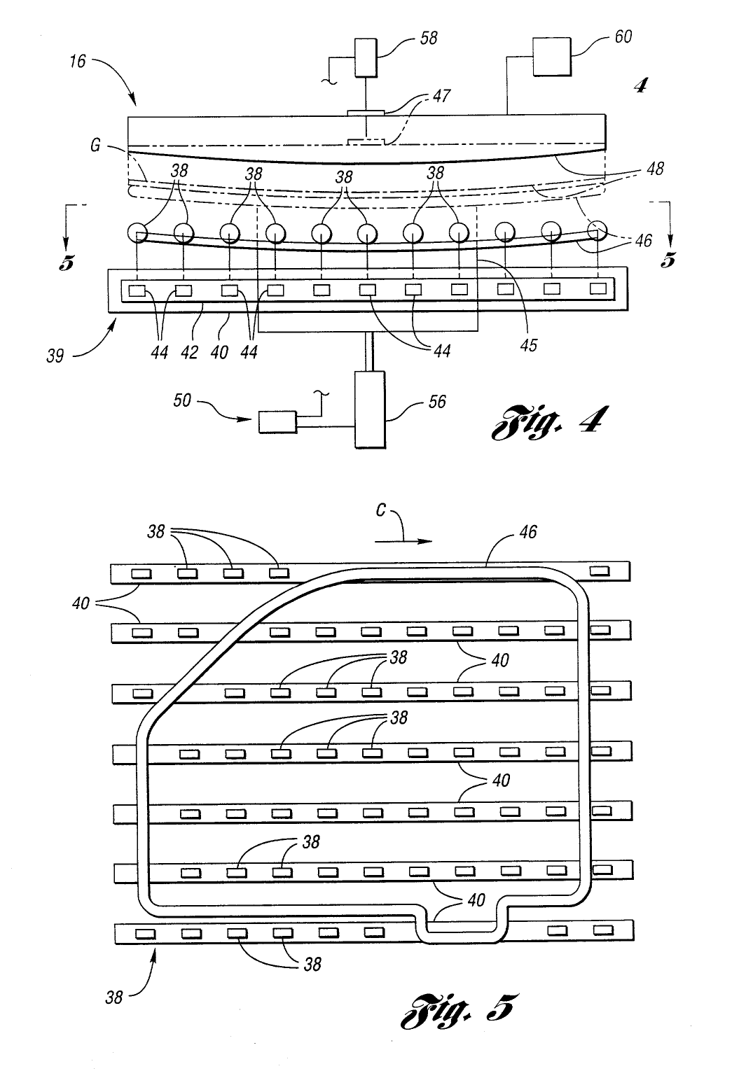

As illustrated in FIGS. 1, 3 and 4, the press bending station actuator 50 includes a lower schematically indicated ball screw operator 56 that moves the lower ring mold 46 vertically and also includes an upper schematically indicated ball screw operator 58 that moves the upper press mold vertically. The cooperative movement of the lower ring mold 46 and the upper press mold 48 thus provides the glass sheet bending of the previously roll bent glass sheet to provide glass sheet forming both along and transverse to the direction of conveyance. At the commencement of each cycle, the lower ring mold 46 is located as illustrated in FIGS. 3 and 4 below the conveyor wheels 38 of the lower wheel bed 36 so as to permit the roll bent glass sheet G to be received thereby in preparation for the press bending. Thereafter, the actuator 50 actuates both the lower and upper operators 56 and 58 to respectively move the lower ring mold 46 upwardly and the upper press mold 48 downwardly to provide the press forming. A vacuum source 60 then draws a vacuum at the upper press mold 48 to support the formed glass sheet. Thereafter, actuator 50 through the lower and upper operators 56 and 58 moves the lower ring mold 56 downwardly and the upper press mold 48 upwardly in preparation for transfer of the formed glass sheet to the quench station 18 and commencement of the next cycle.

With reference to FIG. 1, the quench station 48 includes first and second quench sections 62 and 64 as well as an after-cooling section 66. Each of the first and second quench sections 62 and 64 includes lower and upper quench heads 68 and 70 through which quenching gas is supplied upwardly and downwardly. A shuttle 72 operated by an actuator 74 moves three formed glass sheets progressively from the bending station 16 to the first quench section 62 of the quench station 18, from the first quench section 62 of the quench station to the second quench section 64, and from the second quench section 64 to the after-cooling section 66 where upwardly directed quenching gas from a lower blowup head 76 transfers the glass sheet upwardly to an upper stop 78 to subsequently allow the glass to be transferred to an unshown after-cooling conveyor.

The quench station shuttle 72 illustrated in FIG. 1 has a first ring 80 that is moved toward the left by the actuator 74 to be positioned below the upper press mold 48 and receive the previously formed glass sheet therefrom upon termination of the vacuum from the vacuum source 60 accompanied by pressurized gas supplied to the downwardly facing surface of the upper mold. This ring 80 thus transfers the glass sheet to the first quench section 62 upon movement of the shuttle 72 toward the right. A second ring 82 of the shuttle provides transfer of an initially cooled glass sheet from the first quench section 62 to the second quench section 64. Furthermore, a third ring 84 provides transfer of the quenched glass sheet from the second quench section 64 to the after-cooling section 66 where the lower blowup head 76 provides upwardly directed gas that supports the quenched glass sheet against the upper stop 78 in preparation for transfer to the unshown after-cooling conveyor.

A control 86 of the quench station 18 shown in FIG. 1 controls the gas flow to the lower and upper quench heads 68 and 70 of the first and second quench sections 62 and 64 and to the lower blowup head 76 of the after-cooling section 66. The first quench section 62 cools the glass sheet insufficiently to provide complete tempering thereof without further forced cooling in addition to ambient convection. The control 86 then varies the flow to the lower and upper quench heads 68 and 70 so the upward gas flow from the lower quench head moves the glass sheet upwardly against the upper quench head 70 during transfer movement of the shuttle 72 back toward the left in preparation for the next cycle. The change in the gas flows can be to: (1) increase the upward gas flow; (2) decrease the downward gas flow; or (3) both increase the upward gas flow and decrease the downward gas flow.

At the second quench section 64 shown in FIG. 1, the cooling is sufficient to provide toughening of the glass sheet without further forced cooling in addition to ambient convection. More specifically, this cooling is then sufficient to provide either heat strengthening or tempering. After such cooling at the second quench section 64, the control 86 changes the upward and downward gas flows as is done in the first quench section to move the glass sheet upwardly against the upper quench head 70 at the same time the trailing glass sheet supported upwardly against the upper quench head at the first quench section 62 as previously described. Likewise, the lower blowup head 76 of the after-cooling section 66 then supplies upward gas flow that moves the glass sheet from the ring 84 upwardly against the upper stop 78 in preparation for the after-cooling. The quenching toughens the glass sheet by providing a tensioned glass center and surfaces in compression to increase bending strength and prevent breakage. The rate of quenching may be more moderate to provide heat strengthening or greater to provide tempering.

The manner in which the system 10 described above provides roll bending of glass sheets prior to exiting of the furnace allows the press bending at the press bending station to cooperate with the roll bending and provide relatively rapid transfer to the quench station 18 and thereby permits the complete forming of glass with curvature both along and transverse to the direction of conveyance as well as providing toughening of the forming glass sheet without requiring excessive heating.

The roll bending station 14, the press bending station 16, and the quench station 18 are respectively disclosed by U.S. patent applications: (Docket GLT 1774 PUS); (Docket GLT 1775 PUS); and (Docket GLT 1776 PUS), which are all being filed concurrently herewith and the entire disclosures of which are hereby incorporated by reference.

While the preferred embodiment for practicing the invention has been described in detail, those familiar with the art to which this invention relates will recognize various alternative designs and embodiments for carrying out the invention as described by the following claims.

What is claimed is:

1. A system for forming and quenching glass sheets, comprising:
a furnace having entry and exit ends and including a heating chamber having a conveyor for conveying glass sheets along a direction of conveyance through the furnace from the entry end to the exit end;
the exit end of the furnace including a roll bending station within the heating chamber, the roll bending station including a roll conveyor having horizontally extending conveyor rolls that are rotatively driven and spaced horizontally within the heating chamber along the direction of conveyance extending laterally with respect thereto to support and convey the heated glass sheets, the roll bending station having a pair of sets of bending rolls that are spaced laterally with respect to each other within the heating chamber along the direction of conveyance, and a drive mechanism that supports each set of the bending rolls with the rolls thereof at progressively increasing inclinations along the direction of conveyance and that provides rotational driving of the bending rolls to provide bending of the conveyed glass sheets along a direction transverse to the direction of conveyance;
a press bending station located externally of the furnace downstream along the direction of conveyance from the exit end of the furnace to receive the bent glass sheets from the exit end of the furnace, the press bending station having a lower ring mold and an upper press mold that have curved shapes along and transverse to the direction of conveyance, and an actuator that provides relative vertical movement between the lower ring mold and the upper press mold to bend a glass sheet therebetween and cooperate with the roll bending station in forming the glass sheet with curvatures both along and transverse to the direction of conveyance; and
a quench station for rapidly cooling the formed glass sheet to provide toughening.

2. A system for forming and quenching glass sheets as in claim 1 the drive mechanism is located externally of the furnace with the bending rolls projecting inwardly into the furnace.

3. A system for forming and quenching glass sheets as in claim 1 wherein the press bending station actuator moves the lower ring mold vertically to provide the glass sheet forming.

4. A system for forming and quenching glass sheets as in claim 1 wherein the press bending station actuator moves the upper press mold vertically to provide the glass sheet forming.

5. A system for forming and quenching glass sheets as in claim 1 wherein the press bending station actuator moves both the lower ring mold and the upper press mold vertically to provide the glass sheet forming.

6. A system for forming and quenching glass sheets, comprising:
a furnace having entry and exit ends and including a heating chamber having a conveyor for conveying glass sheets along a direction of conveyance through the furnace from the entry end to the exit end;
the exit end of the furnace including a roll bending station within the heating chamber, the roll bending station including a roll conveyor having horizontally extending conveyor rolls that are rotatively driven and spaced horizontally within the heating chamber along the direction of conveyance extending laterally with respect thereto to support and convey the heated glass sheets, the roll bending station having a pair of sets of bending rolls that are spaced laterally with respect to each other within the heating chamber along the direction of conveyance, and a drive mechanism that is located externally of the furnace and that supports the bending rolls at progressively increasing inclinations along the direction of conveyance as well as providing rotational driving of the bending rolls to provide bending of the conveyed glass sheets along a direction transverse to the direction of conveyance;
a press bending station located externally of the furnace downstream along the direction of conveyance from the exit end of the furnace to receive the bent glass sheets from the exit end of the furnace, the press bending station having a lower ring mold and an upper press mold that have curved shapes along and transverse to the direction of conveyance, and an actuator that moves both the lower ring mold and the upper press mold vertically to bend a glass sheet therebetween and cooperate with the roll bending station in forming the glass sheet curvatures both along and transverse to the direction of conveyance; and
a quench station for rapidly cooling the formed glass sheet to provide toughening.

7. A method for forming and quenching glass sheets comprising:
conveying a glass sheet within a heating chamber of a furnace from an entry end thereof toward an exit end thereof to provide heating thereof for forming;
continuing to convey the heated glass sheet on rotary horizontally extending rolls within the furnace heating chamber adjacent the exit end of the furnace and engaging opposite lateral sides of the roll conveyed glass sheet with a pair of sets of rotatively driven bending rolls that are spaced laterally from each other within the furnace heating chamber with each set having a plurality of bending rolls spaced along the direction of conveyance with progressively increasing inclinations to provide bending of the conveyed glass sheets along a direction transverse to the direction of conveyance;
conveying the bent glass sheet out of the heating chamber of the furnace through the exit end thereof to between a lower ring mold and an upper press mold that have curved shapes along and transverse to the direction of conveyance;
providing relative vertical movement between the lower ring mold and the upper press mold to bend a glass sheet therebetween and cooperate with the initial roll bending to form the glass sheet curvatures both along and transverse to the direction of conveyance; and
thereafter rapidly cooling the formed glass sheet to provide toughening.

8. A method for forming and quenching glass sheets as in claim 7 wherein each set of bending rolls is rotatively supported and driven from externally of the furnace with the bending rolls thereof projecting into the heating chamber.

9. A method for forming and quenching glass sheets as in claim 7 wherein the lower ring mold is moved vertically to press bend the glass sheet.

10. A method for forming and quenching glass sheets as in claim 7 wherein the upper press mold is moved vertically to press bend the glass sheet.

11. A method for forming and quenching glass sheets as in claim 7 wherein both the lower ring mold and the upper press mold are moved vertically to press bend the glass sheet.

12. A method for forming and quenching glass sheets comprising:
conveying a glass sheet within a heating chamber of a furnace from an entry end thereof toward an exit end thereof to provide heating thereof for forming;
continuing to convey the heated glass sheet on rotary horizontally extending rolls within the furnace heating chamber adjacent the exit end of the furnace and engaging opposite lateral sides of the roll conveyed glass sheet with a pair of sets of bending rolls that are rotatively supported and driven from externally of the furnace and spaced laterally from each other with each set having a plurality of bending rolls projecting into the heating chamber and spaced along the direction of conveyance with progressively increasing inclinations to provide bending of the conveyed glass sheets along a direction transverse to the direction of conveyance;
conveying the bent glass sheet out of the heating chamber of the furnace through the exit end thereof to between a lower ring mold and an upper press mold that have curved shapes along and transverse to the direction of conveyance;
moving both the lower ring mold and the upper press mold vertically to bend a glass sheet therebetween and cooperate with the initial roll bending to form the glass sheet curvatures both along and transverse to the direction of conveyance; and
thereafter rapidly cooling the formed glass sheet to provide toughening.
